(19) United States
(12) Patent Application Publication
(10) Pub. No.: US 2016/0102000 A1
(43) Pub. Date: Apr. 14, 2016

(54) Redox Water Treatment Method

(71) Applicants: Marcus George Theodore, Salt Lake City, UT (US); Terry G. Gong, Moraga, CA (US)

(72) Inventors: Marcus George Theodore, Salt Lake City, UT (US); Terry G. Gong, Moraga, CA (US)

(21) Appl. No.: 14/513,773

(22) Filed: Oct. 14, 2014

(51) Int. Cl. C02F 1/70

(52) U.S. Cl. CPC C02F 1/70; C02F 2101/20

(57) ABSTRACT

A redox water treatment method comprises first determining the composition of water and whether water treatment requires either oxidation or redaction, or both to optimize nitrogen removal by a bioreactor. Sulfur dioxide (SO₂) is injected into the water to he treated to provide H⁺, SO₂, SO₃⁼, HS0₃⁻, dithionous acid (H₂S₂O₄), and other sulfur intermediate reduction products forming a sulfur dioxide treated water, which behaves either as a reducing agent or an oxidizing agent depending on the strength of the acid concentration, which alters sulfurous acid from a reducing agent to a more powerful oxidizing agent.

### CROSS-REFERENCE TO RELATED APPLICATIONS

This application is a continuation-in-part patent application of Ser. No. 13/373,169 filed Nov. 7, 2011 entitled “Redox Wafer Treatment Method.”

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

1. Field of the Invention

This invention pertains to redox water treatment methods. In particular it pertains to a redox water treatment method utilizing sulfurous acid to act either as an oxidizing or a reducing solution for water conditioning.

2. State of the Art

Numerous water treatment methods using sulfurous acid are known. Harmon et al, U.S. Pat. No. 7,566,400 issued Jul. 28, 2009 discloses a wastewater chemical/biological treatment method and apparatus for saline wastewater treatment generating biofuels. Harmon et al, U.S. Pat. No. 7,455,773 issued Nov. 25, 2008 discloses a package wastewater chemical/biological treatment plant recovery apparatus and method including soil SAR conditioning. Theodore, U.S. Pat. No. 7,416,668 issued Aug. 26, 2008 discloses a wastewater chemical/biological, treatment plant recovery apparatus and method employing sulfurous acid disinfection of wastewater for subsequent biological treatment Theodore, U.S. Pat. No. 7,563,372 issued Jul. 21, 2009 discloses a package dewatering wastewater treatment system and method including chemical/mechanical separation via drain bags and metal hydroxide removal via lime precipitation. Theodore, U.S. Pat. No. 7,429,329 issued Sept. 30,2008 discloses a hybrid chemical/mechanical dewatering method and apparatus for sewage treatment plants employing sulfurous acid and alkalization chemical treatment along with mechanical separation. Theodore et al, U.S. Pat. No. 7,967,990 issued Jun. 28, 2011 discloses a hybrid chemical/mechanical dewatering method for inactivating and removing pharmaceuticals and other contaminants from wastewater employing a sulfurous hybrid chemical/mechanical dewatering method for inactivating and removing pharmaceuticals and other contaminants from wastewater employing a sulfurous acid and lime acidification/alkalinization cycle, and an oxidation/reduction cycle to selectively precipitate, inactivate, and remove pharmaceuticals from wastewater. Gong et al., U.S. Pat. No. 7,967,989 issued Jun. 28, 2011 discloses a groundwater recharging wastewater disposal method and apparatus using sulfurous acid acidification to enhance soil aquifer treatment Harmon et al, U.S. Pat. No. 7,867,398 issued Jan. 11, 2011 discloses a method and apparatus to reduce wastewater treatment plant footprints and costs by employing vacuum recovery of surplus sulfur dioxide. Theodore (US20080314827) (Theodore '827) adds an oxidizing agent to oxidize chemical species before sulfur dioxide injection. It does not alter the states of the sulfur dioxide itself. Nor does Theodore '827 disclose continuous ORP and DO monitoring of acidified wastewater biological solutions to control and alter their ORP and DO to form oxic and anoxic solutions to promote biological growth in a biological reactor for nitrogen reduction.

FRWA's Training (Method of Controlling Nitrogen) (FRWA) FRWA discloses monitoring of ORP levels, but it does not disclose controlling and solely using sulfurous acid to produce oxidation and reduction solutions conducive to promote bacterial growth in a bioreactor.

The above methods all use sulfurous acid and are therefore dependent upon the sulfur dioxide, sulfite, and bisulfate concentrations in solution and the oxidation/reduction potential of a desired reaction. Sulfurous acid behaves as both an oxidizing and reducing agent, see J. Am. Chem. Soc., 1929, 51 (5) pp 1409-1428, “The Potential of Inert Electrodes, in Solutions of Sulfurous Acid and Its Behavior as an Oxidizing and Reducing Agent” by Arthur A. Noyes, Harold H. Steinour. Consequently, where the waters to be treated vary in nutrient composition, alkaline and saline ionic concentrations, or require biological treatment requiring either a pre-treatment conditioning reducing agent or oxidizing agent, there remains a need for a method to regulate the electrical reduction potential of the sulfurous acid solutions. The method described below provides such a pre-treatment method.

### BRIEF SUMMARY OF THE INVENTION

A redox water treatment method comprises first determining water nutrient composition and whether water treatment requires either oxidation or reduction, or both. The sulfur dioxide (SO₂) is injected into water to be treated to provide H⁺, SO₂, SO₃⁼, HS0₃⁻, dithionous acid (H₂S₂O₄), and other sulfur intermediate reduction products forming a sulfur dioxide treated water, which behaves either as a reducing agent or an oxidizing agent depending on the application required for the combination acted upon and the strength of the acid. An increase in acid concentration makes sulfurous acid a less powerful reducing agent, and a more powerful oxidizing agent.

### DETAILED DESCRIPTION OF THE INVENTION

The present invention comprises a redox water treatment method employing sulfurous acid. It comprises first determining the water's composition and whether water treatment requires either oxidation or reduction, or both. Next, sulfur dioxide (SO₂) is injected into water to be treated to provide H⁺, SO₂, SO₃⁼, HSO₃⁻, dithionous acid (H₂S₂O₄), and other sulfur intermediate reduction products forming a sulfur dioxide treated, water. These species as discussed by Noyes and Steinour may be affected by the presence of other ions in solution, but in general, the acidic sulfur compounds reduce to a lower oxidation state in accordance with the reaction:

3HSO₃⁻=SO₄⁼+S₂O₄⁼+H⁺+H₂O −4660 cal. (4)

The sulfurous acid and dithionous acid electro-motivate the electrode potential so the actual electrode reaction is

S₂O₄⁼+2H₂O=2H⁺+2HSO₃⁻+2 E⁻+415 cal or (5)

S₂O₄⁼=2SO₂(g)+2E⁻+5015 cal (6)

The dithionous acid decomposes in the presence of large hydrogen ion concentrations

according to the equation:

2S₂O₄⁼+H⁺+H₂O=S+3HSO₃⁻+46,590 cal (7)

Sulfur rapidly unites with sulfurous acid to form thiosulfuric acid, but until it has significant concentration, the dithionous acid decomposes in accordance with the equation:

2S₂O₄⁼+H₂O=S₂O₃⁼+2HSO₃⁻44,015 cal (8)

The free-energy values show that Reactions 4, 7 and 9 tend to take place in the direction in which they are written (when the other ion concentrations are 1 molal). At 1 molal, the S₂O₄⁼ has the following values:

Reaction 4, when it is less than 0.0004 molal

Reaction 7, when it is greater than 10-17 molal.

Reaction 8, when it is greater than 10-16 molal.

Thus, sulfurous acid behaves either as a reducing agent or an oxidizing agent depending on the nature of the combination acted upon and the strength of the acid. Further, at a given acid concentration the reduction potential of the combination acted upon need only be varied by a relatively small amount (20 to 40 mv.) in order to change the action of sulfurous acid from a reducing agent to an oxidizing agent. An increase in acid concentration makes sulfurous acid a less powerful reducing agent, and also a more powerful oxidizing agent.

The waters composition and oxidation reduction potential is continuously monitored, and if a reducing solution is required for water treatment, the sulfur dioxide is injected into the water without the addition of additional acid. If an oxidizing solution is required, the sulfur dioxide is injected with air, an oxidizing agent, such as hydrogen peroxide, ferric or ferrous compounds and the pH lowered to provide an oxidizing solution. Oxidation may also require the addition of additional acid. The type of additional acid is selected so that the cations added, do not adversely affect the composition of the resultant treated water. For example, sulfurous acid is preferable to hydrochloric acid as the monovalent chlorides adversely affect the salinity of the water when applied to soils, whereas the bivalent sulfates do not.

If both reduction and oxidization is required for water treatment, first the sulfur dioxide is added to the water to create a reducing solution and held for the dwell time for the reduction mechanisms to effectively reduce the compounds of interest. Next an oxidizing agent (such as air tor ease in handling and availability) and acid are added to the sulfurous acid solution to form an oxidizing solution to oxidize the compounds of interest. The sulfurous acid treated waters are then pH adjusted to a level required by the end user, and to precipitate any heavy metals contained therein for filtration removal. Lime has the advantage of elevating the pH, precipitating heavy metals as metal hydroxides for filtration removal and providing calcium to adjust the sodium adsorption ratio (SAR) when required for soil treatment. Other alkaline compounds, such as ammonia, may be used when additional nitrogen nutrients are required.

With complex waters, such as wastewater, numerous other molecular compounds and components are present. Therefore the amount of sulfurous acid and pH adjustment required must be determined in the field by trial and error as bicarbonates, and other compounds materially affect the amount of sulfur dioxide and acid required for oxidation and reduction. However, the initial estimates of the amount of sulfurous acid may be based on laboratory studies of pure solutions, such as the Noyes and Steinour studies, which found:

“. . . Sulfur dioxide at 25° at 1 atm. In an aqueous solution containing hydrogen ion at 1 molal may be expected to behave toward other oxidation-reduction combinations of substances in three different ways according as the reduction potential of the latter (a) is more negative than −0.37 volt; (b) lies between −0.37 and −0.14 volt; and (c) is more positive than −0.14 volt. (It may he recalled that the value −0.37 is the potential which sulfur dioxide has, under the specified conditions, with respect to its conversion into dithionite ion S₂O₄³² as it exists in the steady reaction state, and that −0.14 is the potential which it has with respect to its conversion to sulfate ion, SO₄⁼, at 1 molal.) For it is evident that sulfur dioxide may oxidize any combination with a reduction potential more reducing (less negative) than −0.37 volt, and that it may reduce any combination which has a potential more oxidizing (more negative) than −0.14 volt. Therefore it may either oxidize or reduce any combination with a potential between −0.37 and −0.14 volt, and which of these two possible effects actually occurs will depend on the relative rates of the oxidizing reaction and the reducing reaction.”

Thus, after determining the water's composition and whether water treatment requires either an oxidizing or reducing solution, or both, sulfur dioxide (SO₂) with minimal oxygen or oxygen containing compounds is injected into the water to create a reducing solution in one mode, or sufficient oxygen or oxygen containing compounds into the sulfur dioxide treated water to create an oxidizing solution in another mode.

The acid pH concentration is similarly adjusted to either insure the electrical conductivity level of the sulfur dioxide treated water is sufficient for release of electrons from the sulfur dioxide, sulfites, bisulfites, and dithionous acid to form a reducing solution to:

i. reduce oxidants and compounds,

ii. disinfect pathogens,

iii. acid leach heavy metals from suspended solid into solution, or

iv. Self-agglomerate suspended solids.

Alternatively, the acid concentration is increased in the presence of oxygen or oxygen, containing compounds sufficiently to accept electrons when the sulfurous acid treated water acts as an oxidizing solution.

Where self-agglomerating suspended solids are present, they are removed and disposed of after sulfur dioxide treatment along with any adsorbed polar molecules to produce a filtrate containing heavy metals. Conditioning of these solids is defined as treating the solids with sufficient SO₂ allowing them chemically to self-adhere to aid in their separation and removal from filtration screens or membranes, but at a level not affecting the permeation characteristics of a filter or membrane. Based on field tests at the Montalvo Municipal Improvement District wastewater treatment plant, self-agglomeration occurs at a pH of approximately 3 to 6.5 resulting in fine suspended solids, which drop to the bottom of percolation ponds, leaving a clear effluent where the bottom can be seen at a depth of 7 to 8 feet as opposed to 2 feet with no acid treatment. These separated conditioned solids chemically dewater upon draining to a water content of less than 10.

The pH of the filtrate is then raised with an alkaline reagent, such as lime to precipitate heavy metals for removal as metal hydroxides. After removal, a disinfected demetalized filtrate results suitable for raising crops or biological treatment.

The electrical conductivity varies based on the composition of the waters to be treated, but is between −0.37 and −0.14 volt at 25° C., at 1 molal H⁺ for culinary waters. This is continually monitored using various meters, such as ORP meters, to determine when conditions change from an oxidizing to a reducing solution.

Preferably, the sulfur dioxide gas is generated by oxidation of elemental sulfur for injection and capture into an aqueous solution via water scrubbing of a stream of either treated or untreated wastewater to form sulfurous acid (H₂SO₃). When used to pre-treat and disinfect wastewater, SO₂ conditioning generally results in a color change of the solids from a dark brown to a lighter gray brown color. Similarly, the SO₂ treated liquids generally change from a greenish color to a lighter gray brown colloidal suspension color. The malodorous smell of the raw wastewater is replaced by a slight acidic smell. Consequently, the conditioning point for the wastewater can easily be determined by injecting more and more SO₂ into the wastewater until the color and odor changes occur-usually observed at a pH of approximately between 1.5 and 3.

The basic acid disassociation chemical reactions of SO₂ in water are:

SO₂+H₂O [symbol] H₂SO₃ sulfurous acid

H₂SO₃ [symbol] H⁺+HSO₃⁻ bisulfite pK=1.77

HSO₃⁻ [symbol] H⁺+SO₃⁼ sulfite pK=7.20

This means 50% of the SO₂ is gas at pH 1.77 and 50% is HSO₃⁻. In a similar manner, 50% is HSO₃⁻ and 50% is SO₃⁼ at pH 1.2. Halfway between pH 1.2 and 1.77 is 5.43 as the pH where all of the sulfur exists as the HSO₃⁻ form. At a pH of 10.86, all of the sulfur should exist as SO₃⁼.

Making an aqueous solution too acidic (pH 0) will result in an excess of SO₂ gas in solution. This will be the point of maximum biocidal activity. However, this will mean the SO₂ gas will vent out of solution exposing the operator to SO₂ without adequate precautious. This can be avoided at the point of about pH 5.43 where dominantly HSO₃⁻ will exist. The acid level is thus selected and monitored to ensure the concentration of the SO₂ and acid will not adversely affect the health of operators or damage handling equipment.

Use of sulfurous acid for water disinfection avoids the need for chlorine gas, bleach (active hypochlorous acid HOCl), hydrogen peroxide (H₂O₂) or ozone (O₃) to prevent the formation of biofilms.

Where the SO2 treated waters are land applied as soil amendments, it may require further adjustment to meet the following:

a. SAR. The Sodium Adsorption Ratio (SAR) indicates the relative activity of sodium, ions as they react with clay. The SAR is a property of the water phase. The SAR determines the relative hazard caused by applying water having a high SAR to soil When the SAR is high (>15), more of the sodium (Na⁺) ions in the solution phase will become adsorbed onto the solid phase (clay minerals and humus) of the soil. This solid phase of clay minerals and humus contains a net negative electrical charge and is termed the soil Cation Exchange Capacity (CEC). As more sodium ions are adsorbed to the solid phase, the soil aggregates composed of large conglomerations of sand, silt, clay and humus particles become destabilized. This condition is termed dispersion, disaggregation or deflocculation. The result is the transformation of the aggregates into their individual sand, silt, clay and humus particles as opposed to the previously aggregated particles. The result of this transformation is the destruction of the soil's ability to transmit air, water and nutrients to plant roots. As these dispersed silt and clay particles move downward, they cover the previously existing soil pores and effectively block further water infiltration and penetration through the soil. Typically, SAR is adjusted with the addition of more calcium ions from salts, such as lime, spent, lime, hydrated lime, gypsum, etc. adjustment.

b. MVCAR. Technically, the SAR should be expanded to include all monovalent cations. Thus, we also use the Mono-Valent Cation Adsorption Ratio (MVCAR), rather than simply the SAR as a measure of potential hazard of the liquid water phase solution. These monovalent cations normally present in water and soils include sodium (Na⁺), potassium (K⁺) and ammonium (NH₄+) ions. Municipally treated waste water effluent often has an elevated level of sodium and of ammonium ions. Irrigation of a soil with this type of water (high MVCAR) can cause dispersion, disaggregation, or deflocculation of the soil particles and is usually off-set with similar calcium salt addition.

c. EC—to insure adequate water infiltration and water permeability through the soil, the Electrical Conductivity (EC) of irrigation water should be brought to greater than 0.3 ds/m or greater than 0.3 mmhos/cm. with the addition of soluble calcium. This prevents deflocculation or dispersion of the soli. When water has been treated to remove all of the major cations [namely, calcium (Ca²⁺), magnesium (Mg²⁺), sodium (Na⁺), potassium (K⁺) and ammonium (NH₄⁺) ions], then another problem occurs. As the total salt concentration approaches zero (as occurs when the Electrical Conductivity EC of the water approaches zero), the soil will disperse easily. This condition occurs during Reverse Osmosis (RO) conditions applying pure filtrate for irrigation. The reason for this dispersion is the system must have a relative equilibrium of adsorbed (solid phase) cations and solution phase cations to maintain the stability of the soil aggregates.

The solution to the soil dispersion problem is first to know what the EC and SAR or MVCAR are for a specific water intended for use as irrigation or for use in water recharge of any underground aquifer. It has long been recognized a high SAR or MVCAR can cause this problem. However, the lower the EC of the water used for irrigation, the greater the soil dispersion hazard of using this water. Second, the only way to insure this problem will not manifest itself and prevent dispersion of the soil system is to add additional soluble calcium (Ca²⁺) ions to the system (regardless of whether the cause is a high SAR or MVCAR or a very low EC in the liquid phase).

The added soluble calcium, for this counter dispersion process is usually derived from either of two sources: Gypsum (calcium sulfate dihydrate) or calcium carbonate spent lime plus sulfur dioxide (SO₂) forming calcium sulfite reacting to form soluble calcium ions. Gypsum addition has the advantage of being pH neutral. Both generate soluble calcium (Ca²⁺) ions in. the solution phase, which are attracted to the solid phase CEC sites of the soil particles resulting in flocculation and aggregate stabilization. Failure to amend water applied to soil will result in die eventual destruction of the soil aggregates and cause dispersion, disaggregation and deflocculation.

This dispersion, disaggregation and defloculation hazard can occur under all conditions when the EC is very low (as occurs with rain water, snow melt water or RO treated water). Again, it is critical to increase the level of soluble calcium (Ca²⁺) and. acidity (H⁺) ions when this very low EC condition occurs in water applied to soil. Irrigation with water having a high ammonium concentration (as occurs with ammonium fertilizer injected into irrigation water) or when municipally treated waste water is irrigated can also result in soil dispersion. Again, an adequate concentration of soluble calcium ions is used to prevent the dispersion, disaggregation or deflocculation of the soil system. The presence of magnesium (Mg²⁺) ions is usually insufficient to correct this problem.

A high concentration of bicarbonate and/or carbonate can exacerbate the monovalent cation problem. When bicarbonate and/or carbonate are present they react with the soluble calcium and magnesium converting these ions Into insoluble calcium carbonate and magnesium carbonate. This process removes the required calcium ions from the solution phase. This magnifies the problem because the calcium concentration appears in the lower fraction of the SAR or the MVCAR formula. The result is the ratio becomes multiplied as a consequence of this precipitation of previously soluble calcium and magnesium ions. Hence, the SAR measurement is retained in the claims to indicate how the retentates are monitored and adjusted to avoid either very low EC conditions or high SAR conditions.

d. pH. The pH of any soil, system is also important to insure the pH is near a value of 6.5 (thereby reducing the problem of high bicarbonate and/or carbonate soil plugging) and insuring the presence of soluble calcium ions existing in the treated system. Failure to make a pH adjustment will cause precipitation of the calcium carbonate and magnesium carbonate. These insoluble carbonates will form inside the existing soil pores and will eventually plug these pores, thereby inhibiting the subsequent movement of water downward through the soil.

From the SAR, the proportion of sodium on the clay can be estimated when irrigation water has been used for a long period with reasonable irrigation practices. The SAR is a good index of the sodium permeability hazard if water passes through the soil and reaches equilibrium with it. From long experience, if the SAR is less than 3, there should be no problems with either sodium or permeability. In the range of 3 to 9, there are increasing problems. Above 9, severe problems can be expected.

A number of state and federal agencies have surveyed soils and preferred crop conditions throughout the United States. For example, the US Department of Agriculture Agricultural Research Service (USDAARS) base established various soil measurement guidelines. Its laboratory personnel have established criteria for diagnosing saline and sodic soils. Electrical conductivity (EC) of the soil saturation extract was introduced as a practical index of soil salinity. The threshold EC value of 4 dS/m is still used worldwide to diagnose and classify saline soils. A threshold of 15 for the exchangeable sodium percentage (ESP) defined as the ratio of sodium (Na) to the total cation exchange capacity [ESP=((Na⁺ cmol/kg)/(CEC cmol/kg))*100], indicates soil sodicity and permeability and structural problems.

Key practical diagnostic criteria used to evaluate a water's suitability for irrigation and its potential for degrading soils were developed at the USDAARS Salinity Laboratory. These include electrical conductivity (EC) mentioned above, sodium adsorption ratio (SAR), adjusted SAR and boron (B) hazard. Electrical conductivity is the universal standard measure of water salinity hazard. Sodium adsorption ratio is also a universal standard indicating water potential to cause sodic conditions and poor soil structure. Both of these indicators are critical for management decisions and together constitute the basis of a classification system for waters with respect to their salinity and sodicity hazard. Adjusted SAR was developed to correct the measure of sodium hazard for the tendency of calcium carbonate to precipitate from irrigation waters and to improve the appraisal of water quality, predicting potential infiltration problems.

The USDAARS Laboratory has also been at the forefront of determining the boron and salt tolerance of enumerable plant species. One USDAARS Laboratory study quantified all available salt tolerance data by presenting threshold salinity values for yield decrease and linear yield decrease per unit of salinity. Thus a given crop's response to salinity can be described using only two variables, thereby simplifying the selection of an appropriate crop for waters and soils of a given salinity. Salt tolerance tables, thresholds, and yield responses are provided in all manuals and handbooks dealing with crop production on saline soils and/or with saline waters and are used world-wide.

Salt balance and leaching requirements for water used for irrigation has also been established. The salt balance is the difference between the salt input and the salt output for a given irrigation project, and is used to evaluate the adequacy of drainage facilities, leaching programs, and water requirements for removing salts, and sustaining irrigation in general. This method is still used in monitoring programs by many irrigation projects. The leaching requirement establishes the fraction of irrigation water that must be leached through the root zone to maintain an acceptable level of salinity for cropping purposes. Minimized leaching concepts developed by the USDAARS Laboratory were at the core of the water quality control measures adopted for implementation to control salinity of the Colorado River.

USDAARS Laboratory scientists have been at the forefront in developing reclamation procedures and guidelines for saline and sodic soils. To reclaim saline soils, leaching strategies especially continuous ponding and intermittent ponding were developed by Laboratory scientists and are universally used. To reclaim sodic soils, they pioneered the use of the soil amendments: gypsum, sulfuric acid, sulfur, and calcium chloride to replace exchangeable sodium along with leaching. The gypsum requirement, the amount of amendment required to affect reclamation of a given amount of exchangeable sodium, was developed at the Salinity Laboratory and is the universally-used reclamation standard.

These studies established that plants exhibit differences in salinity tolerance at various growth stages. The information allows a cyclical watering strategy where good quality water was used for growth of sensitive crops during sensitive growth stages, while saline drainage water may be used for the growth of tolerant crops or during tolerant growth stages. The U.S. Bureau of Reclamation and the California Resources Agency have adopted minimized leaching and drainage water reuse concepts to conserve water, minimize drainage volumes, and protect water quality as the heart of the San Joaquin Valley Drainage Program.

A preferred sulfurous acid pre-treatment apparatus is as follows. Although sulfur dioxide from tanks associated with a contact mixer can he used to acidify the water to be pretreated, a sulfurous acid generator, such as those produced by Harmon Systems International, LLC of Bakersfield, Calif., is preferred as they are designed to produce the SO₂ on demand and on an as needed basis. The SO₂ is immediately captured in an aqueous form as sulfurous acid (H₂SO₃) preventing harmful operator exposure. The sulfur dioxide is injected into the water at a pH between approximately 1.5 and approximately 3.5, depending upon the dwell time required for conditioning and disinfection. At these pH ranges, sufficient SO₂ is generated to condition solids for separation, and disinfection and deodorizing wastewater. It was found through testing the Harmon sulfurous acid generator can condition and treat incoming raw wastewater solids to self-agglomerate into colloidal self-adhering solids which do not adhere to surfaces The Harmon sulfurous acid generator has the advantage of generating SO₂, as needed, avoiding the dangers of tank storage and accidental release. However, the main advantage in passing the water directly through the sulfurous acid generator is that it creates and introduces onsite SO₂ without adding other compounds or materials such as when using sodium meta-bisulfite and/or potassium meta bisulfite into the system, or additional acid compounds for pH lowering. The method uses both unfiltered and filtered water as the medium to scrub and form the sulfurous acid. Consequently, the treated water volume is not affected.

In one preferred pre-treatment embodiment, the water is fed directly through the Harmon sulfurous acid generator to create a concentrated solution of sulfurous acid (H₂SO₃), which immediately separates and becomes H⁺, and HSO₃⁻. Doing this enhances the redox process because: 1.) Sulfurous Acid will neutralize the Total Alkalinity. 2.) The resulting Bisulfite (HSO₃⁻)/SO₂ will attack microorganisms within the water for disinfection. 3.) Provide a means in which dissolved oxygen can be scavenged and removed from the water to enhance chemical reduction. 4.) Since the resultant material will be sulfate (sol) enriched, this material can now bond (with other constituents within the water) to form useful compounds (such as calcium sulfate) and have the potential of transforming brines in the treated water into desirable and marketable compounds, such as a calcium rich supplement added to replenish depleted soil environments found in areas of high rainfall and/or calcium deficiency).

In summary, the above method provides a redox water treatment method to produce waters suitable for various soil regions, and soil conditions.

Where complex organic or wastewaters are to be conditioned for bioreactor treatment to reduce nitrogen containing compounds, the method is adapted as follows: First, determining the water's salts, ions, molecular, and chemical composition and whether water treatment requires either oxidation or reduction, or bath to enhance nitrogen removal in a bioreactor. Next, sulfur dioxide (SO₂) is injected into water to be treated to provide H⁺, SO₂, SO₃⁼, HSO₃⁻, dithionous acid (H₂S₂O₄), and other sulfur intermediate reduction products forming a sulfur dioxide treated water as discussed above.

Thus, sulfurous acid behaves either as a reducing agent or an oxidizing agent depending on the nature of the combination acted upon and the strength of the acid. Further, at a given acid concentration the reduction potential of the combination acted upon need only be varied by a relatively small amount (20 to 40 mv.) in order to change the action of sulfurous acid from a reducing agent to an oxidizing agent. An increase in acid concentration makes sulfurous acid a less powerful reducing agent, and also a more powerful oxidizing agent.

If a reducing solution is required for bioreactor water treatment, the sulfur dioxide is injected into the water without the addition of additional acid. If an oxidizing solution is required for bioreactor treatment, the sulfur dioxide is injected with air, an oxidizing agent, such as hydrogen peroxide, ferric or ferrous compounds and the pH lowered to provide an oxidizing solution. Oxidation may also require the addition of additional acid. The type of additional acid is selected so that the cations added do not adversely affect the composition of the resultant treated water. For example, sulfurous acid is preferable to hydrochloric acid as the monovalent chlorides adversely affect the salinity of the process water when applied to soils, whereas the bivalent sulfates do not.

If both reduction and oxidization Is required for water treatment, first the sulfur dioxide is added to the water to create a reducing solution and held for the dwell time for the reduction mechanisms to effectively reduce the compounds of interest. Next an oxidizing agent (such as air for ease in handling and availability) and acid are added to the sulfurous acid solution to form an oxidizing solution to oxidize the compounds of interest. The sulfurous acid treated bioreactor process waters are then pH adjusted to a level required by the end user, and to precipitate any heavy metals contained therein for filtration removal. Lime has the advantage of elevating the pH, precipitating heavy metals as metal hydroxides for filtration removal and providing calcium to adjust the sodium adsorption ratio (SAR) when required for soil treatment. Other alkaline compounds, such as ammonia, may be used when additional nitrogen nutrients are required.

With complex waters, such, as wastewater, numerous other compounds and components are present. Therefore the amount of sulfurous acid and pH adjustment required must be determined In the field by trial and error as bicarbonates, and other compounds materially affect the amount of sulfur dioxide and acid required for oxidation and reduction. However, the initial estimates of the amount of sulfurous acid may be based on laboratory studies of pure solutions, such as the Noyes and Steinour studies, discussed above.

Wastewaters contain nitrogen, biological oxygen demand components (BOD), chemical oxygen demand components (COD), and total suspended solids (TSS), which are treated in a biological reactor for nutrient removal. These biological reactors may be enhanced by employing the present redox reduction method employing sulfurous acid and lime comprising:

controlling and monitoring the composition of wastewater or wastewater process streams in a bioreactor to be treated and whether the wastewater and wastewater process steams require biological nutrient removal under oxidation or reduction conditions, or both.

injecting sulfur dioxide (SO₂) into the wastewater to be treated to provide H⁺, SO₂, SO₃⁼, HSO₃⁻, dithionous acid (H₂S₂O₄), and other sulfur intermediate reduction products forming a sulfur dioxide treated wastewater with agglomerated suspended solids and acid leached heavy metals in solution, which form either:

an oxidizing solution in the presence of oxygen and sufficient acid to insure that the electrical conductivity level of the sulfur dioxide treated wastewater is sufficient to accept electrons, or

a reducing solution in the presence of minimal oxygen and no additional acid to insure the electrical conductivity level of the sulfur dioxide treated wastewater is sufficient for release of electrons from the sulfur dioxide, sulfites, bisulfites, and dithionous acid,

removing the suspended solids forming an oxidizing or reducing solution filtrate,

adding lime to the oxidizing or reducing solution filtrate to precipitate heavy metals as metal hydroxides, and phosphates as calcium phosphate precipitates,

removing metal hydroxides and calcium phosphate precipitates forming a pH adjusted oxidizing or reducing solution to stimulate biological nutrient removal; and

selectively monitoring and altering the sulfur dioxide injected wastewater to form either an oxidizing solution or reducing solution, or both in a bioreactor at the oxidation reduction potential (ORP) and dissolved oxygen (DO) level/levels required to accelerate biological removal of nitrogen compounds forming a conditioned wastewater.

This redox wastewater biological nutrient removal treatment method generally includes measuring and monitoring the ORP electrical conductivity levels of a bioreactor used for bacterial removal of nutrients from wastewater to determine if the bioreactor requires an oxidizing or reducing solution, or both. Nitrification is the oxidation of Ionized ammonia (NH₄⁺) to nitrate (NO₃⁻) and is performed by nitrifying bacteria when the ORP of the wastewater is +100 to +350 mV.

Denitrification is the reduction of nitrate (NO₃⁻) to molecular nitrogen (N₂) and is performed by denitrifying bacteria with ORP of the wastewater is +50 to −50 mV. The exact ORP may vary based on the bioreactor conditions and often reads between −0.37 and −0.1.4 volt at 25° C. at 1 molal H⁺ for denitrification.

Where the treated wastewater requires additional carbon for the denitrifying bacteria, spent lime is added.

To enhance oxidation, the redox wastewater biological nutrient removal includes injecting hydrogen peroxide, oxygen containing compounds, and ferrous compounds into the sulfur dioxide treated wastewater oxidizing solution to adjust the electrical conductivity level of the sulfur dioxide treated wastewater sufficiently to accept electrons to enhance the oxidizing solution.

Similarly, the redox wastewater biological nutrient removal treatment method adds additional acid to the sulfur dioxide treated wastewater to make a more powerful oxidizing solution where required. This additional acid for oxidation is selected to provide compatible anions consistent with the discharge needs of the end user.

If a stronger reducing solution is required, additional sulfites and bisulfites salts are added to the sulfur dioxide treated wastewater reducing solution to adjust the electrical conductivity level of the sulfur dioxide treatment wastewater sufficiently to donate electrons to enhance the reducing solution.

pH adjustment for land application is usually accomplished by adding lime and calcium carbonate to adjust the pH and calcium ion concentration of the conditioned wastewater to provide soil concentrations with a sodium absorption ratio (SAR) less than 15, soli electrical conductivity (EC) less than 2 dS m⁻¹ (m mho cm⁻¹), cation exchange capacity (CEC) less than 57.5 centimoles/kg, and a pH less than 8; the specific soil ratios and concentration levels selected for raising a particular crop and reducing soil bicarbonates/carbonates to increase soil porosity and improve water penetration. Usually the pH is held between 2 and 6.8 for alkaline soil land application.

Where both oxidation and reduction are required for biological nutrient removal, the redox wastewater biological nutrient removal treatment method comprises:

determining and controlling the composition of wastewater or wastewater process streams to be treated in a sequential batch reactor for biological nutrient removal under both oxidation and reduction conditions,

injecting sulfur dioxide (SO₂) and oxygen into the wastewater to be treated to provide H⁺, SO₂, SO₃⁼, HSO₃⁻, dithionous acid (H₂S₂O₄), and other sulfur intermediate reduction products forming a sulfur dioxide treated wastewater with agglomerated suspended solids and acid leached heavy metals In solution under oxic or aerobic conditions where the oxidation reduction potential (ORP) and dissolved oxygen level (DO) is sufficient for the sulfur dioxide treated water to accept electrons to create an oxidizing solution for nitrification to occur for bacteria to break down ammonia into nitrite and then into nitrate compounds,

stopping oxygen injection into the nitrified wastewater to form a reducing solution under anoxic anaerobic conditions where the oxidation reduction potential (ORP) is adjusted to insure that the electrical conductivity level of the sulfur dioxide treated wastewater is sufficient to donate electrons to create a reducing solution for denitrification to occur where bacteria breaks down the nitrates into nitrogen,

removing the suspended solids from the denitrified solution forming a filtrate,

adding lime to the filtrate to precipitate heavy metals as metal hydroxides, and phosphates as calcium phosphate precipitates, and

removing metal hydroxides and calcium phosphate precipitates forming a pH adjusted recovered wastewater suitable for land application.

This redox wastewater biological nutrient removal treatment method using sulfur dioxide treated nitrified wastewater under oxic or aerobic conditions has an ORP between +50 and +300 mV for nitrifying bacteria to nitrify ammonia to form nitrites and nitrobacteria then convert the nitrite to nitrate. An ORP between +50 and −50 mV under anoxic anaerobic conditions is adjusted and held for facultative bacteria to denitrify and convert the nitrates to nitrogen gas.

If pH buffering is required, the redox wastewater biological nutrient removal treatment method usually adds spent lime to buffer the sulfur dioxide and oxygen treated nitrified wastewater under oxic conditions and provide additional carbon for denitrification to occur.

The redox water method thus provides an oxidation/reduction water treatment method for oxidizing and reducing compounds of interest in waters to be treated. When used for complex waters, such as wastewaters, the redox water treatment method enhances bioreactor removal of nitrogen compounds by reducing shock loads on them, and holding the oxidation reduction potentials at levels, which enhance nitrification and denitrification using organic sulfurous acid and lime compounds.

We claim:

1. A redox water treatment method employing sulfurous acid comprising:
a. determining the compounds of interest in water to be treated and whether the compounds require oxidation, reduction, or both,
b. injecting sulfur dioxide (SO₂) into the water to be treated to provide H⁺, SO₂, SO₃⁻², HSO₃⁻, dithionous acid (H₂S₂O₄), and other sulfur intermediate reduction products forming a sulfur dioxide treated water either:
i. in the presence of oxygen, air, an oxidizing agent, such as hydrogen peroxide, ferric or ferrous compounds, and additional sulfur dioxide and any other acid to ensure that the electrical conductivity level of the sulfur dioxide treated water is sufficient to accept electrons to create an oxidizing solution to oxidize compounds of interest, or
ii. in the presence of no oxygen and without additional other acid added for reduction to occur, but more sulfur dioxide can be added to ensure the electrical conductivity level of the sulfur dioxide treated water is sufficient for release of electrons from the sulfur dioxide, sulfites, bisulfites, and dithionous acid to form a reducing solution to reduce oxidants, disinfect pathogens, acid leach heavy metals from suspended solids into solution, and self-agglomerate suspended solids, and
c. adjusting and selectively employing the oxidation reduction potential electrical conductivity levels of the sulfur dioxide treated water_required for providing either an oxidizing or reducing solution, or both.

2. A redox water treatment method according to claim 1, including:
a. removing and disposing of suspended solids from the reducing solution along with adsorbed polar molecules to produce a filtrate containing heavy metals, and
b. raising the pH of the sulfur dioxide treated water with lime to precipitate any heavy metals, which form metal hydroxides for removal and forming a disinfected demetalized filtrate suitable for biological treatment.

3. A redox water treatment method employing sulfurous acid according to claim 1, including injecting hydrogen peroxide or other oxygen containing compounds into the sulfur dioxide treated water to ensure that the electrical conductivity level of the sulfur dioxide treated water is sufficient to accept electrons to enhance the oxidizing solution.

4. A redox water treatment method according to claim 1, including adding additional sulfites and bisulfites from a different source in addition to that contained in the sulfur dioxide treated water.

5. A redox water treatment method according to claim 1, wherein the electrical conductivity is between −0.37 and −0.14 volt at 25° C. at 1molal H⁺.

6. A redox water treatment method according to claim 1, wherein the additional acid is selected so that, cations added do not adversely affect resultant treated water.

7. A redox water treatment method comprising:
a. determining the ionic and molecular composition of water to be treated for oxidation and reduction,
b. injecting sulfur dioxide (SO₂) into water to be treated to provide H⁺, SO₂, SO₃⁼², HS03⁻, dithionous acid (H₂S₂O₄), and other sulfur intermediate reduction products forming a sulfur dioxide treated water in the presence of the amount of oxygen necessary for reduction to occur and no additional other acid is added, but more sulfur dioxide can be added to ensure the electrical conductivity level of the sulfur dioxide treated water is sufficient for release of electrons from the sulfur dioxide, sulfites, bisulfites, and dithionous acid to form a reducing solution to reduce oxidants, disinfect pathogens, acid leach heavy metals from suspended solids into solution, and self agglomerate suspended solids, and
c. removing and disposing of suspended solids from the reducing solution along with adsorbed polar molecules to produce a filtrate containing heavy metals,
d. injecting oxygen and other additional acid including more sulfur dioxide into the filtrate to insure that the electrical conductivity level of the sulfur dioxide treated water is sufficient to accept electrons to create an oxidizing solution, and
e. raising the pH of the sulfur dioxide treated water with lime to precipitate heavy metals for removal as metal hydroxides to form a disinfected demetalized filtrate suitable for raising crops and biological treatment.

8. A redox water treatment method according to claim 7, including adding lime and/or calcium carbonate to adjust the pH and calcium ion concentration of the discharged brine retentates to provide soil concentrations with a sodium adsorption ratio SAR less than 15, electrical conductivity EC less than 2 dS m⁻¹ (m mho cm⁻¹), cation exchange capacity CEC less than 57.5 centimoles/kg, and a pH less than 8.

9. A redox water treatment method according to claim 8, wherein the concentration of sulfurous acid bus a pH between 2 and 6.8 for land application to alkaline soils.

10. A redox water treatment method according to claim 1, wherein the sulfurous acid reducing solution has a free SO₂ and bisulfite (HSO₃⁻) concentration, a pH level, and a dwell time sufficient to affect disinfection before land application.

11. A redox water treatment method according to claim 8, wherein the oxidizing solution is first raised to a pH level of up to 11 using lime to precipitate any heavy metals, which form metal hydroxides as metal hydroxides for removal, and the resultant metal free filtrate is then pH lowered for raising plants and biological treatment, and providing a soil sodium adsorption ratio_SAR level suitable for plant propagation and reduce soil carbonates/bicarbonates to improve water penetration.

12. A redox water treatment method according to claim 1, wherein the water is wastewater containing nitrogen compounds, total suspended solids (TSS), biological oxygen demand compounds (BOD), chemical oxygen demand compounds (COD) undergoing biological nitrogen reduction in a bioreactor, including:
a. controlling and monitoring the composition of wastewater or wastewater process streams entering the bioreactor to be treated and whether the wastewater and wastewater process steams require biological nutrient removal under oxidation or reduction conditions, or both,
b. injecting sulfur dioxide (SO₂) into the wastewater to be treated to provide H⁺, SO₂, SO₃⁻, HSO₃⁻, dithionous acid (H₂S₂O₄), and other sulfur intermediate reduction products forming a sulfur dioxide treated wastewater with agglomerated suspended solids and acid leached heavy metals in solution, which form either:
i. in the presence of oxygen and sufficient acid to insure that the electrical conductivity level of the sulfur dioxide treated wastewater is sufficient to accept electrons to create an oxidizing solution, or
ii. in the presence of minimal oxygen and no additional acid to insure the electrical conductivity level of the sulfur dioxide treated wastewater is sufficient for release of electrons from the sulfur dioxide, sulfites, bisulfites, and dithionous acid to form a reducing solution,
c. removing the suspended solids forming either an oxidizing or reducing solution filtrate,
d. adding lime to the oxidizing or reducing solution filtrate to precipitate heavy metals as metal hydroxides, and phosphates as calcium phosphate precipitates,
e. removing metal hydroxides and calcium phosphate precipitates forming a pH adjusted, oxidizing or reducing solution second filtrate and transferring the second filtrate to the bioreactor; and
f. selectively monitoring and altering the oxidation reduction potential (ORP) of the second filtrate to form either an oxidizing solution or reducing solution, or both in the bioreactor at the oxidation reduction potential (ORP) and dissolved oxygen (DO) level/levels required to stimulate and accelerate biological removal of nitrogen compounds forming a conditioned wastewater.

13. A redox water treatment method according to claim 12, wherein the ORP electrical conductivity is adjusted and held at an mV required for nitrification.

14. A redox water treatment method according to claim 13, wherein after nitrification, the ORP electrical conductivity is adjusted and held at an mV required for denitrification.

15. A redox water treatment method according to claim 12, wherein the second filtrate is treated under oxic or aerobic conditions at an ORP between +50 and +300 mV for nitrification, and an ORP between +50 and −50 mV under anoxic anaerobic conditions for denitrification.

16. A redox water treatment method according to claim 14, wherein the lime added is spent lime, which adds additional carbon if required by denitrifying bacteria.

17. A redox water treatment method according to claim 12, including injecting hydrogen peroxide, oxygen containing compounds, and ferrous compounds info the second filtrate to adjust the electrical conductivity level sufficiently to accept elections to enhance the oxidizing solution.

18. A redox water treatment method according to claim 17, including adding additional acid to the second filtrate to make a more powerful oxidizing solution.

19. A redox water treatment method according to claim 18, wherein the additional acid for oxidation is selected to provide compatible cations consistent with the discharge needs of an end user.

20. A redox water treatment method according to claim 12, including adding additional sulfites and bisulfites from salts to the second filtrate reducing solution to adjust the electrical conductivity level of the sulfur dioxide treatment wastewater sufficiently to donate electrons to enhance the reducing solution.

21. A redox water treatment method according to claim 1, including adding lime and calcium carbonate to adjust the pH and calcium ion concentration of the conditioned wastewater for land application to provide soil concentrations of sodium absorption ratio (SAR) less than 15, soil electrical conductivity (EC) less than 2 dS m⁻¹ (m mho cm⁻¹), cation exchange capacity (CEC) less than 57.5 centimoles/kg, and a pH less than 8; the specific soil ratios and concentration levels selected for raising a particular crop and reducing soil bicarbonates/carbonates to increase soil porosity and improve water penetration.

22. A redox water treatment method according to claim 21, wherein the concentration of sulfurous acid of the conditioned wastewater has a pH between 2 and 6.8 for alkaline soil land application.
